(19) United States
(12) Patent Application Publication
(10) Pub. No.: US 2024/0004173 A1
(43) Pub. Date: Jan. 4, 2024

(54) OPTICAL ASSEMBLY AND OPTICAL APPARATUS

(71) Applicant: Shphotonics Ltd, Suzhou (CN)

(72) Inventors: Lei SUN, Suzhou (CN); Shanfeng QIU, Suzhou (CN); Bing QIU, Suzhou (CN)

(21) Appl. No.: 18/341,301

(22) Filed: Jun. 26, 2023

(30) Foreign Application Priority Data
Jul. 1, 2022 (CN) 202210775482.2

(51) Int. Cl. G02B 17/02; G02B 1/00

(52) U.S. Cl. CPC G02B 17/023; G02B 1/002

(57) ABSTRACT

An optical assembly includes a first substrate and a second substrate that extend parallel to a reference plane and are separated from each other in a direction perpendicular to the reference plane; and a plurality of optical elements that are arranged parallel to the reference plane and include a first metasurface element and a second metasurface element. The first metasurface element is embedded in the first substrate and/or the second metasurface element is embedded in the second substrate. The first metasurface element and the second metasurface element are configured such that one of the first metasurface element and the second metasurface element reflects at least a portion of light to another one of the first metasurface element and the second metasurface element.

### CROSS-REFERENCE TO RELATED APPLICATION

This application claims priority to Chinese Application No. 202210775482.2, filed on Jul. 1, 2022, the entire content of which is incorporated herein by reference.

### TECHNICAL FIELD

The present disclosure relates to the technical field of optics and, in particular, to an optical assembly and an optical apparatus.

### BACKGROUND

In related technologies, an optical assembly of, e.g., a mobile phone, an augmented reality apparatus, or a virtual reality apparatus, has the problem of large thickness and low optical transmittance because the structure thereof needs for satisfying certain optical length requirements.

### SUMMARY

One aspect of the present disclosure provides an optical assembly. The optical assembly includes a first substrate and a second substrate that extend parallel to a reference plane and are separated from each other in a direction perpendicular to the reference plane; and a plurality of optical elements that are arranged parallel to the reference plane and include a first metasurface element and a second metasurface element. The first metasurface element is embedded in the first substrate and/or the second metasurface element is embedded in the second substrate. The first metasurface element and the second metasurface element are configured such that one of the first metasurface element and the second metasurface element reflects at least a portion of light to another one of the first metasurface element and the second metasurface element.

Another aspect of the present disclosure provides an optical apparatus. The optical apparatus includes an optical assembly. The optical assembly includes a first substrate and a second substrate that extend parallel to a reference plane and are separated from each other in a direction perpendicular to the reference plane; and a plurality of optical elements that are arranged parallel to the reference plane and include a first metasurface element and a second metasurface element. The first metasurface element is embedded in the first substrate and/or the second metasurface element is embedded in the second substrate. The first metasurface element and the second metasurface element are configured such that one of the first metasurface element and the second metasurface element reflects at least a portion of light to another one of the first metasurface element and the second metasurface element.

### BRIEF DESCRIPTION OF THE DRAWINGS

To more clearly illustrate the technical solutions in the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an exemplary optical assembly according to some embodiments of the present disclosure.

FIG. 2 is a schematic structural diagram of another exemplary optical assembly according to some embodiments of the present disclosure.

FIG. 3 is a schematic diagram showing comparison between a reference optical assembly and an exemplary optical assembly according to some embodiments of the present disclosure.

FIG. 4 is a schematic diagram showing a first embedded structure and a second embedded structure according to some embodiments of the present disclosure.

FIG. 5 is a schematic structural diagram of an exemplary optical apparatus according to some embodiments of the present disclosure.

Reference numerals: 100—optical assembly; 110—first metasurface element; 111—substrate; 112—nanostructure unit; 120—second metasurface element; 130—image sensor; 140—light source; 150—aperture; 160—lens; 1701—first substrate; 1702—second substrate; 171—first embedded structure; 1711—first positioning portion; 1712—first chamfered portion; 172—second embedded structure; 1721—second positioning portion; 1722—second chamfered portion; 200—optical apparatus; 001—optical assembly; 011—first metasurface element; 012—second metasurface element; 0171—first substrate; 0172—second substrate; and 013—image sensor.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of fabrication techniques and/or tolerances, can be expected. Thus, embodiments of the present disclosure should not be interpreted as being limited to the specific shapes of regions illustrated in the drawings, but are to include deviations in shapes that result, for example, from fabrication. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

In related technologies, for example, an optical assembly of an optical apparatus, such as a mobile phone, an augmented reality device, or a virtual reality device, generally has a problem of relatively large thickness because the structure thereof needs to satisfy design requirements of optical length. The optical assembly of the optical apparatus often adopts a folded optical path design which uses multiple semi-transparent mirrors to fold the optical path such that light can travel a same length in a narrower space. Although this solution can reduce a thickness of the optical assembly to a certain extent, the light will be subject to substantial loss after multiple reflections, resulting in a low light transmittance efficiency of the optical assembly. The light transmittance efficiency is a numerical value representing actual light transmission ability of a lens, and is one of important indicators of lens performance.

The present disclosure provides an optical assembly and an optical apparatus to improve the light transmittance efficiency of the optical assembly while designing light and thin optical assembly.

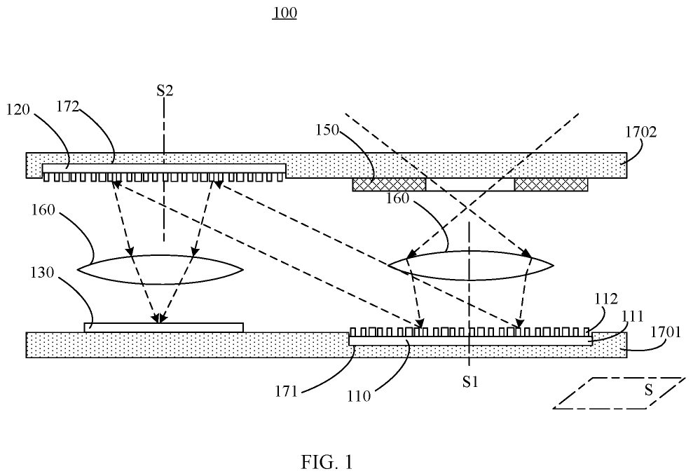

In some embodiments, as shown in FIG. 1, the optical assembly 100 includes a first substrate 1701 and a second substrate 1702 extending parallel to a reference plane S and a plurality of optical elements arranged parallel to the reference plane S. The first substrate 1701 and the second substrate 1702 are separated from each other in a direction perpendicular to the reference plane S. The plurality of optical elements include a first metasurface element 110 and a second metasurface element 120. The first metasurface element 110 is embedded in the first substrate 1701, and/or the second metasurface element 120 is embedded in the second substrate 1702. In some embodiments, as shown in FIG. 1, the first metasurface element 110 is embedded in the first substrate 1701, and the second metasurface element 120 is embedded in the second substrate 1702. In some other embodiments, the first metasurface element 110 and the second metasurface element 120 do not necessarily have to be both embedded in their corresponding substrates. Additionally, although in the example of FIG. 1, an optical axis of the first metasurface element 110 and an optical axis of the second metasurface element 120 do not coincide with each other, this is not required. The first metasurface element 110 and the second metasurface element 120 are configured such that one of the first metasurface element 110 and the second metasurface element 120 reflects at least a portion of received light to the other of the first metasurface element 110 and the second metasurface element 120.

In some embodiments, the first metasurface element 110 and the second metasurface element 120 are configured such that one of the first metasurface element 110 and the second metasurface element 120 reflects at least a portion of the received light to the other of the first metasurface element 110 and the second metasurface element 120. For example, the first metasurface element 110 may be configured to receive reflected light from the second metasurface element 120. As another example, as shown in FIG. 1, the second metasurface element 120 may be configured to receive reflected light from the first metasurface element 110.

The present disclosure is not limited to any specific product type of the optical assembly 100. For example, the optical assembly 100 may be a camera of a mobile terminal, a virtual reality device, an augmented reality device, a light emitter, or the like. In addition to the plurality of optical elements, the optical assembly 100 may also include related installation structures for providing support and positioning for the plurality of optical elements, such as a housing with a certain inner space. The first substrate 1701 and the second substrate 1702 can be a part of the housing, and can be made of a transparent material. The plurality of optical elements may be mounted at the housing as needed.

In addition to the first metasurface element 110 and the second metasurface element 120, the plurality of optical elements may also include one or more of a converging element, a diverging element, a diffraction grating element, a transmittance grating element, a polarizing element, a filtering element, and a dispersion element, etc. The present disclosure does not specifically limit the type, specification, and quantity of these optical elements. These optical elements may be designed in conventional structures. For example, the converging element may be a convex lens, and the diverging element may be a concave lens. In some embodiments, one or more of these optical elements may also adopt a metasurface design and include a metasurface structure.

A metasurface refers to an artificial two-dimensional (2D) material whose basic structural units are smaller than the operation wavelengths, and are usually on the order of nanometers. The metasurface element may be used to flexibly and effectively control characteristics such as electromagnetic wave polarization, amplitude, phase, and propagation mode. The metasurface element is ultra-light and ultra-thin. Compared with conventional optical elements, the metasurface elements have the advantage of excellent optical performance, compact size, and high level of integration.

As shown in FIG. 1, the metasurface element mainly includes a substrate 111 and a nanostructure layer disposed at a side of the substrate 111. The nanostructure layer includes a plurality of nanostructure units 112 (the shape in the drawing is only for illustration and does not represent the actual structure). Based on the design of the plurality of nanostructure units 112, effects of various lenses or combination of lenses, such as optical convergence, divergence, deflection, transmittance, reflection, diffraction, dispersion, and chromatic aberration adjustment can be achieved. Light can be deflected according to a designed target path, such that the metasurface element can achieve a desired optical effect.

In some embodiments, at least one of the first metasurface element 110 and the second metasurface element 120 may also be configured to disperse, converge, diverge, or transmit received light.

In some embodiments, the first metasurface element 110 and/or the second metasurface element 120 may also be configured to transmit a portion of the received light (not shown) to have a transflective effect.

In some embodiments, the first metasurface element 110 and/or the second metasurface element 120 may also be configured to converge a portion of the received light (not shown) to achieve a convergence effect of a conventional convex lens.

In some embodiments, the first metasurface element 110 and/or the second metasurface element 120 may also be configured to diverge a portion of the received light (not shown) to achieve a divergence effect of a conventional concave lens.

In some embodiments, the first metasurface element 110 and/or the second metasurface element 120 may also be configured to disperse a portion of the received light (not shown) to achieve a dispersion effect of a triangular prism, a diffraction grating, or an interferometer.

In some embodiments, the first metasurface element 110 and/or the second metasurface element 120 may also be configured to simultaneously have at least two of convergence, dispersion, divergence, or transmittance function. For example, a portion of an area of a certain metasurface element is configured to converge the received light while another portion of the area is configured to diverge the received light, such that the metasurface element achieve both the converging effect and the diverging effect at the same time.

The optical assembly 100 may include one or more optical elements of appropriate type, specification, and quantity, such that the one or more optical elements can be combined according to a certain configuration to achieve a desired optical effect. A light-emitting end of an optical system constructed by using the optical assembly 100 may be a screen (such as a light-emitting diode (LED) display, an organic light-emitting diode OLED display, a micro-light-emitting diode micro-LED display), a vertical cavity surface emitting laser (VCSEL), a laser diode (LD), or a scanning fiber, etc. A light receiving end of the optical system constructed by the optical assembly 100 may be human eyes, a complementary metal oxide semiconductor (CMOS) sensor, a charge-coupled device (CCD) sensor, or an optical power meter, etc.

In some embodiments, as shown in FIG. 1, the optical assembly 100 is an imaging optical system, and the plurality of optical elements include an image sensor 130. After sequentially passing through an aperture 150 and one or more lenses 160, the light is directed to the first metasurface element 110. The first metasurface element 110 reflects the received light to the second metasurface element 120, and the second metasurface element 120 reflects and converges the received light. The light passes through the one or more lenses 160 and then reaches the image sensor 130 (e.g., a CMOS sensor). The image sensor 130 converts the optical signal into a corresponding electrical signal for output.

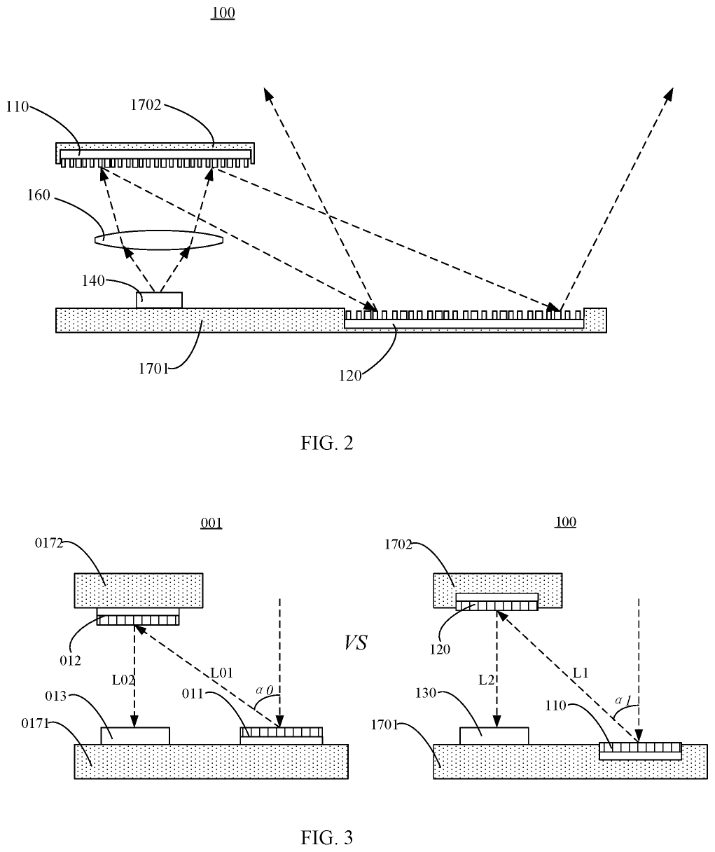

In some embodiments, as shown in FIG. 2, the optical assembly 100 may also be an optical emission system, and the plurality of optical elements include a light source 140, such as a micro-LED light source 140. Light emitted by the light source 140 is directed to the first metasurface element 110 after sequentially passing through the one or more lenses 160. The first metasurface element 110 reflects and diverges the light received to the second metasurface element 120. The second metasurface element 120 diverges the light (in some embodiments, it can also converge the light) and reflects the light. The light is then sent to a target object outside the optical assembly 100.

The technical solutions of the disclosed embodiments have the following technical effects.

Based on the ultra-light and ultra-thin properties of metasurface elements, the first metasurface element 110 and the second metasurface element 120 are used to fold the optical path to achieve the light and thin design of the optical assembly 100 and to reduce packaging complexity of the optical assembly 100. By properly designing the plurality of nanostructure units in the nanostructure layer of the metasurface elements, deflection of light at a preset angle can be achieved, thereby reducing the thickness of the optical assembly. By properly designing the plurality of nanostructure units in the nanostructure layer of the metasurface elements, the optical properties of the metasurface elements can be flexibly adjusted, such that it is easier to achieve the desired optical effect and reduce optical loss. In addition, compared to disposing the first metasurface element 110 and the second metasurface element 120 on the surface of the corresponding substrate, embedding the first metasurface element 110 in the first substrate 1701 and/or the second metasurface element 120 in the second substrate 1702 can increase an optical length inside the optical assembly, or further reduce the thickness of the optical assembly if the optical length remains unchanged. In addition, the embedded design of the metasurface elements also reduces a deflection angle of the light, which helps to reduce the optical loss and improve the light transmittance efficiency of the optical assembly.

FIG. 3 is a schematic structural diagram showing comparison between a reference optical assembly 001 and an exemplary optical assembly 100 according to some embodiments of the present disclosure. The reference optical assembly 001 (on the left) includes a first substrate 0171, a second substrate 0172, a first metasurface element 011 and an image sensor 013 disposed on the first substrate 0171, and a second metasurface element 012 disposed on the second substrate 0172. As shown in FIG. 3, an optical path L1+L2 inside the optical assembly 100 according to some embodiments of the present disclosure is longer than an optical path L01+L02 inside the reference optical assembly 001. The deflection angle α1 of the light inside the optical assembly 100 is smaller than the deflection angle α0 of the light inside the reference optical assembly 001.

Therefore, compared with the related art, the design of the embodiments of the present disclosure improves the light transmittance efficiency of the optical assembly.

In some embodiments, as shown in FIG. 1, the first substrate 1701 includes a first embedded structure 171, and the first metasurface element 110 is located in the first embedded structure 171. The second substrate 1702 includes a second embedded structure 172, and the second metasurface element 120 is located in the second embedded structure 172. In this way, the optical length inside the optical assembly 100 can be greatly increased. In some other embodiments, only one of the metasurface elements is embedded inside the corresponding substrate.

The first embedded structure 171 may be a first embedded groove (as shown in FIG. 1) or a first embedded through-hole, and the second embedded structure 172 may be a second embedded groove (as shown in FIG. 1) or a second embedded through-hole. Structural forms of the first embedded structure 171 and the second embedded structure 172 may be the same or different.

The surface of the first metasurface element 110 can be flush with, or protrude or recess relative to, the surface of the first substrate 1701, and the surface of the second metasurface element 120 can be flush with, or protrude or recess relative to, the second substrate 1702. The beneficial effects can be achieved in any scenario.

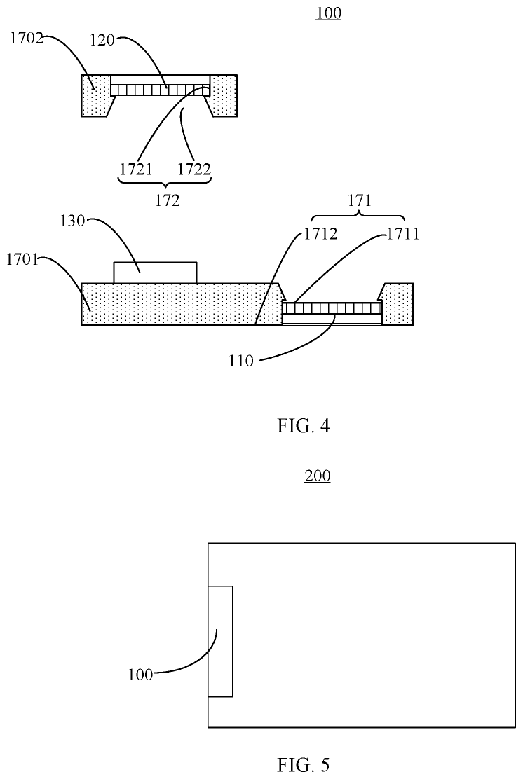

In some embodiments, as shown in FIG. 4, the first embedded structure 171 is a first embedded through-hole, including a first positioning portion 1711 and a first chamfered portion 1712 sequentially arranged in a thickness direction of the first substrate 1701. The first metasurface element 110 is located in the first positioning portion 1711 and adjacent to the first chamfered portion 1712. The second embedded structure 172 is a second embedded through-hole, including a second positioning portion 1721 and a second chamfering portion 1722 arranged sequentially in a thickness direction of the second substrate 1702. The second metasurface element 120 is located in the second positioning portion 1721 and adjacent to the second chamfered portion 1722.

In this implementation design, the first metasurface element 110 and the second metasurface element 120 may be attached (for example, being bonded by an adhesive layer) to their corresponding substrate from the outside (for example, from the outside of the housing). Thus, the first metasurface element 110 and the second metasurface element 120 can be mounted in the first positioning portion 1711 of the first embedded through-hole and the second positioning portion 1721 of the second embedded through-hole, respectively.

The first chamfered portion 1712 and the second chamfered portion 1722 may be configured as oblique chamfers or rounded chamfers. The chamfered portions may reduce the blocking of the light by edges of the embedded structures, such that more light can be directed to the metasurface elements or emit from the metasurface elements, which improves the light transmittance efficiency of the optical assembly 100.

As shown in FIG. 5, the present disclosure further provides an optical apparatus 200 including the optical assembly 100 of any embodiment of the present disclosure. The type of the optical apparatus 200 includes but not is limited to a camera of a mobile terminal, a virtual reality device, an augmented reality device, an optical transmitter, etc. The optical assembly 100 of the optical apparatus 200 is designed to be lighter and thinner, and has higher light transmittance efficiency and better optical performance.

This specification provides many different embodiments or examples that can be used to implement the present disclosure. These different embodiments or examples are purely exemplary and are not intended to limit the scope of the present disclosure in any way. Those skilled in the art can conceive of various changes or substitutions on the basis of the disclosure content in the specification of the present disclosure, and these should be within the scope of the present disclosure. Therefore, the protection scope of the present disclosure should be defined by the appended claims.

What is claimed is:

1. An optical assembly comprising:
a first substrate and a second substrate that extend parallel to a reference plane and are separated from each other in a direction perpendicular to the reference plane; and
a plurality of optical elements that are arranged parallel to the reference plane and include a first metasurface element and a second metasurface element,
wherein:
the first metasurface element is embedded in the first substrate and/or the second metasurface element is embedded in the second substrate; and
the first metasurface element and the second metasurface element are configured such that one of the first metasurface element and the second metasurface element reflects at least a portion of light to another one of the first metasurface element and the second metasurface element.

2. The optical assembly of claim 1, wherein:
the first substrate includes a first embedded structure, and the first metasurface element is located in the first embedded structure; and
the second substrate includes a second embedded structure, and the second metasurface element is located in the second embedded structure.

3. The optical assembly of claim 2, wherein:
the first embedded structure includes a first embedded groove or a first embedded through-hole; and
the second embedded structure includes a second embedded groove or a second embedded through-hole.

4. The optical assembly of claim 2, wherein:
a surface of the first metasurface element is flush with a surface of the first substrate, or protrudes or recesses relative to the surface of the first substrate; and
a surface of the second metasurface element is flush with a surface of the second substrate, or protrudes or recesses relative to the surface of the second substrate.

5. The optical assembly of claim 2, wherein:
the first embedded structure includes a first embedded through-hole including a first positioning portion and a first chamfered portion sequentially arranged in a thickness direction of the first substrate, the first metasurface element being located in the first positioning portion and adjacent to the first chamfered portion; and
the second embedded structure includes a second embedded through-hole including a second positioning portion and a second chamfered portion sequentially arranged in a thickness direction of the second substrate, the second metasurface element being located in the second positioning portion and adjacent to the second chamfered portion.

6. The optical assembly of claim 1, wherein:
the first substrate and the second substrate are parts of a housing of the optical assembly.

7. The optical assembly of claim 1, wherein:
at least one of the first metasurface element and the second metasurface element is configured to converge, disperse, diverge, or transmit the light.

8. The optical assembly of claim 1, wherein:
the plurality of optical elements further include one or more of a converging element, a diverging element, a diffraction grating element, a transmittance grating element, a polarizing element, a filtering element, and a dispersion element.

9. The optical assembly of claim 1, wherein:
the plurality of optical elements further include one or more of the converging element, the diverging element, the diffraction grating element, the transmittance grating element, the polarizing element, the filtering element, and the dispersion element, that include a metasurface structure.

10. The optical assembly of claim 1, wherein:
the optical assembly is an imaging optical system, and the plurality of optical elements further include an image sensor; or
the optical assembly is an optical emission system, and the plurality of optical elements further include a light source.

11. An optical apparatus comprising an optical assembly, the optical assembly including:
a first substrate and a second substrate that extend parallel to a reference plane and are separated from each other in a direction perpendicular to the reference plane; and
a plurality of optical elements that are arranged parallel to the reference plane and include a first metasurface element and a second metasurface element,
wherein:
the first metasurface element is embedded in the first substrate and/or the second metasurface element is embedded in the second substrate; and
the first metasurface element and the second metasurface element are configured such that one of the first metasurface element and the second metasurface element reflects at least a portion of light to another one of the first metasurface element and the second metasurface element.

12. The optical apparatus of claim 11, wherein:
the first substrate includes a first embedded structure, and the first metasurface element is located in the first embedded structure; and
the second substrate includes a second embedded structure, and the second metasurface element is located in the second embedded structure.

13. The optical apparatus of claim 11, wherein:
the first embedded structure includes a first embedded groove or a first embedded through-hole; and
the second embedded structure includes a second embedded groove or a second embedded through-hole.

14. The optical apparatus of claim 12, wherein:
a surface of the first metasurface element is flush with a surface of the first substrate, or protrudes or recesses relative to the surface of the first substrate; and
a surface of the second metasurface element is flush with a surface of the second substrate, or protrudes or recesses relative to the surface of the second substrate.

15. The optical apparatus of claim 12, wherein:
the first embedded structure includes a first embedded through-hole including a first positioning portion and a first chamfered portion sequentially arranged in a thickness direction of the first substrate, the first metasurface element being located in the first positioning portion and adjacent to the first chamfered portion; and
the second embedded structure includes a second embedded through-hole including a second positioning portion and a second chamfered portion sequentially arranged in the thickness direction of the second substrate, the second metasurface element being located in the second positioning portion and adjacent to the second chamfered portion.

16. The optical apparatus of claim 11, wherein:
the first substrate and the second substrate are parts of a housing of the optical assembly.

17. The optical apparatus of claim 11, wherein:
at least one of the first metasurface element and the second metasurface element is configured to converge, disperse, diverge, or transmit the light.

18. The optical apparatus of claim 11, wherein:
the plurality of optical elements further include one or more of a converging element, a diverging element, a diffraction grating element, a transmittance grating element, a polarizing element, a filtering element, and a dispersion element.

19. The optical apparatus of claim 11, wherein:
the plurality of optical elements further include one or more of the converging element, the diverging element, the diffraction grating element, the transmittance grating element, the polarizing element, the filtering element, and the dispersion element, that include a metasurface structure.

20. The optical apparatus of claim 11, wherein:
the optical apparatus is a camera of a mobile terminal, a virtual reality device, an augmented reality device, or a light emitter.
